(19) United States
(12) Patent Application Publication
(10) Pub. No.: US 2007/0079663 A1
(43) Pub. Date: Apr. 12, 2007

(54) Resonant maglev centrifugal propulsion

(76) Inventor: Mark Alan Tanner, Los Angeles, CA (US)

Correspondence Address: Mark Alan Tanner, Unit 6, 1558 Brockton Ave, Los Angeles, CA, 90025, US

(21) Appl. No.: 11/505,531

(22) Filed: Aug. 17, 2006

Related U.S. Application Data
(60) Provisional application No. 60/720,247, filed on Sep. 23, 2005.

(51) Int. Cl. F03G 3/00

(52) U.S. Cl. 74/84 S

(57) ABSTRACT

A device to employ directed centrifugal force for use as rectilinear motion utilizing a novel harmonic motion, oscillating arcing eccentric mass resonator, which flexes about an axis of rotation with limited angular displacement. The stator and rotating oscillator are technically a single mass, in that they are magnetically coupled to provide an elastic tension K and thus produce a natural resonant frequency form, such as a tuning fork. Said eccentric centrifugal mass is also coupled by centripetal magnetic levitation force and thus has no frictional load, therefore. The preferred embodiment uses two sets of like thrusters and like frequency but one set is 90 degrees out of phase with the other set. This arrangement is able to cancel out any recoil force on the vehicle mass. Thrust is amplitude modulated. The oscillating momentum of the mass is amplified for greater thrust at the resonant frequency. The device may be employed for any mode of travel.

This application claims priority to provisional application No. 60/720,247 filed on Sep. 23, 2005.

### REFERENCES CITED

Foreign Patent Documents

| | | | |
|---|---|---|---|
| WO2004032314 | 2002 | AU | H02K041/035. |
| 1547762 | August, 1976 | GB | 74/84. |
| 2279434 | January, 1993 | GB | F2X X15 |

### REFERENCES CITED

U.S. Patent Documents

| | | | |
|---|---|---|---|
| 4238968 | December, 1980 | Cook | 74/84. |
| 2350248 | May, 1944 | Nowlin | 74/61. |
| 3555915 | January, 1971 | Young, Jr. | 74/84. |

### BACKGROUND OF THE INVENTION

1. Field of Invention

The field of endeavor to which the invention pertains is space drive propulsion. These devices provide forward motion to a vehicle by providing enclosed internal unbalanced force and thus does not require mass to be ejected to do so. The classification is 74 sub class 84 S among others.

2. Description of Prior Art

The prior art, which most closely resembles the present invention, is patent UK 2,279,434 wherein the invention works to move two independent symmetric eccentric rods, in opposite reciprocal motion about a common axis. Each rod is a slave to a long curved stator respectively, for acceleration and deceleration, then beginning the process again with no stored potential energy and is not a resonant system. Except for the common friction type axel, the two rod like rotors are for all intensive purposes two separate eccentric rotary motors. Thus this invention is highly inefficient because full power is need to accelerate and break the reciprocating masses rotors.

The second invention, which may seem to be similar to this application, is patent WO2004032314 wherein magnetic forces are used to propel sliding radial magnetic pistons away from the stator toward the axis as they rotate into position. Said pistons are seated on stops located at the terminus of said rotating structure and thus centrifugal forces will produce a load on the mechanical bearing as they push outward against said stops. This system hence is not a maglev or magnetic centripetal force bearing or rail such as the applications is clamed to be.

### SUMMARY OF THE INVENTION

The substance or general idea of the claimed invention in summarized as providing a useful and novel means to generate directed centrifugal force and propulsion with unprecedented energy efficiency. The new method to achieve this is a novel centrifugal force producing, magnetic-mechanical harmonic oscillator of high Q factor, which is externally force driven at its natural harmonic frequency by electromagnetic means. The unique oscillating resonator is forced to rotate about an axis with centripetal magnetic levitation bearing means.

The invention produces maximum thrust when the eccentric oscillating resonator is in the apogee vector of said arc. Minimum energy is required to replace the Q energy losses of the oscillating mass because the resonator is magnetically suspended The eccentric mass resonator oscillates freely on a single plane of rotation due to a pare of novel ball thruster bearings. Said ball thruster bearings serve only to maintain precise tolerance of said oscillator on a fixed plane of rotation. The side loading on said ball bearings is negligent as the oscillator is in a position of equilibrium betwixt the magnetic stators. A novel improvement in the invention makes use of the phenomenon that a single mass structure is one that must have a natural resonant frequency that stores and releases said energy repeatedly at a harmonic frequency similar to a tuning fork. Conversely, separate masses do not form a single resonant frequency. The invention, though an assembly, is actually a single mass structure, which flexes together and apart under magnetic elastic tension. Said structure resonates with expanding and contracting oscillation motion not unlike a tuning fork or wine glass. The prior art utilize separate non-resonate mass structures means. This invention is also novel in its use of centripetal magnetic levitation to achieve highly energy efficient thrust .For the first time; thousands of pounds of centrifugal thrust can be generated with virtually no loss due to friction.

### DESCRIPTION OF THE PREFFERED EMBODIMENT

This invention relates to a device for producing directed unbalanced centrifugal motive force and movement in a desired direction. No patent in this field has ever been commercially successful for reasons addressed by the present patent.

According to the present invention there is provided a novel device for producing highly efficient and powerful motive force comprising a novel harmonic motion eccentric centrifugal oscillator, resonating under stiff magnetic torsion displacement. Said magnetic force provides both the resonant oscillation mechanism means as well as a centripetal magnetic levitation bearing means to transfer the centrifugal thrust to the invention hosing with virtually no frictional loss due to centrifugal force load .The invention includes electromagnetic driving means arranged to impart momentum to the centrifugal resonator's arc oscillation at the resonant frequency of the oscillation.

Reduced to practice, this arrangement produces a superior highly directional unbalanced centrifugal force and useful linear motion and said force is greatest at the apogee of the circular arc sector. The thrust generated is a rectified sinusoidal impulse, being at a minimum when the resonator (s) are at the extremes of the arc displacement, and at a maximum during peak velocity. Said thrust force is a radial vector through the arc apogee.

The resonant arc(s) thrust is amplitude and frequency modulated.

Preferably, the driving force means to phase pump said resonator is in the form of electromagnetic torque actuator, and the driver of said actuator can be controlled by any electronic method such designed to do so. Electromagnet torque actuator coil turns are preferably close to the resonator permanent magnetic pole(s).

Preferably, the device includes electromagnetic driving control means arranged to initially accelerate the resonator from rest at apogee radial vector The resonator (s) displace along their respective anti-parallel arc paths and thereafter the restoring magnetic force K coupling said resonators decelerates said resonator(s) to zero velocity at the extreme ends of the arc then return the resonator with magnetic torsion to the equilibrium position substantially with the stored magnetic tension energy. Once back to the position where momentum plus a preferred driving impulse accelerates the anti parallel resonators to the opposite ends of the respective arc once again to desired amplitude simultaneously. The process then automatically repeats and thus forced displacement of elastic harmonic resonance is employed. Most preferably, said driving means is in the form of electromagnetic pulses which amplify or maintain the oscillation amplitude of the resonator (s) for thrust magnitude control.

Further, the resonating arc mass is made to pivot about an axis by centripetal magnetic levitation bearing means which can be electronically dynamic active controlled to provide greater stiffness and centrifugal load or non active magnetic coupling.

Orienting a device(s), mounted to the vehicle provides control of said vehicle's motion. Moreover, oppositely directing the centrifugal forces is effective for breaking the vehicle.

The present invention can be constructed using state of the art magnetic bearing manufacturing process and materials. The preferred magnets used are neodymium or other high gauss type engineered to reduce eddy currents. The resonant oscillator is preferably consecutive rows of ferrous metal, also engineered to reduce eddy currents, alternately with rows of neodymium magnet of like facing poles, so that concentrated flux paths can be employed that interlace and thwart vertical motion by the resonator wherein, like repelling poles prevent vertical slip but not the horizontal slip, hence acting as a retaining magnetic bearing. The electromagnet torque actuator is preferably soft ferrite or thin lamination magnetic steel or the like.

### DESCRIPTION OF THE SEVERAL VIEWS OF THE DRAWING

FIG. 1 is a somewhat perspective plan view of a device for producing motive force in accordance with an embodiment of the present invention; and

FIG. 2 is an isolated component view of the device of FIG. 1,showing components of the device separated.

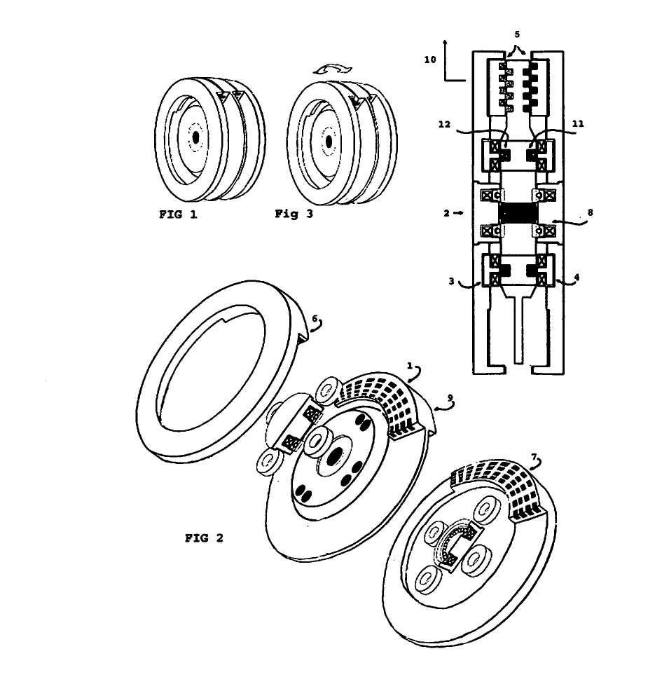

Including an eccentric centrifugal electromechanical maglev resonator structure 1 comprised of oscillator eccentric magnetic resonator, which circumscribes a substantially fixed axis 2, which is supported by a centripetal maglev bearing assemblies 5 respectively, and central permanent magnet electric generator with ceramic thruster ball bearing units 8. Said maglev bearing also maintains a frictionless, substantially fixed, pivot axis of said rotor.

Oscillatory movement of said oscillator rotor is produced by means of electromagnetic torque impulse actuator 3, and coupling actuator magnet sets 11,12, arranged to provide the necessary energy to the resonator in phase with the oscillation. In FIG. 2 the resonator is shown in the apogee position where the magnetic poles of said resonator interlace with maglev bearing magnets 6, 7 providing oscillation magnetic tension K as well as the centripetal tension.

Electrical power is supplied to the torque actuator sets 3, 4 via a circuit controller power supply means not shown.

When operating the eccentric oscillating mass resonator 1, it initially stands at rest in the apogee position of the arc, defined by the sweep or amplitude and is supported in the apogee position via a magnetic coupling with the maglev bearing resonator core juxtaposed thereto 5. Power is then supplied to the torque actuator 3 and 4, to produce magnetic a force to displace the magnetic resonator 1 wherein said resonator moves or stretch along the arc path FIG. 3 and thereafter the restoring magnetic force “K” then returns the magnetic rotor to the apogee. Upon reaching the apogee of the arc, with the eccentric oscillator resonator mass 9 in substantial alignment in the apogee position, the driver device controller operates to reverse the polarity to the actuator sets if needed 2, 3, and thus are driven in the opposite direction as before, adding to the tangent kinetic energy amplitude for greater thrust The process is then repeated to maintain propulsive force in direction 10.

As this oscillation movement of the resonator 1 occurs, the centrifugal forces generated by the magnetically coupled resonator mass 1 act together to provide a resultant maximum force through the apogee of the arc synchronized in tandem effectively dampens undesired vibration to their pivot axis respectively.

While the resultant centrifugal force is intermittent, the direction remains rectilinear and the magnitude of the force controllable by changing the amplitude of the resonant oscillator1 increase as the square of resonator velocity. The oscillator1 provides a maximum thrust at maximum amplitude. Only the key internal parts are shown in the Drawing page.

To reduce the air resistance which the oscillator 1 experience, the resonators can be located in a chamber of partial vacuum or low pressure atmosphere of low atomic weight atoms such as helium. If necessary, heat may be dissipated by other cooling methods.

If the device is mounted in a vehicle, the direction of the resultant force will typically be aligned with the apogee vector of the centrifugal force and hence the direction of travel The device may be fixed such that a motive force may only be produced in one direction. An array of like devices may be rotate able mounted in individual XYZ 360 degrees axis pivot gimbal such that the direction of said resultant forces may be varied to change the trajectory or vehicle position, or to break the vehicle.

From the above description it will be clear to those skilled in the art that various modifications and improvements made thereto can be made without departing from the scope of the invention and that the above described embodiments are merely exemplary of the present invention.

What I claim as my invention is:

1. Method for producing directed centrifugal propulsive force comprising resonant oscillating arc eccentric mass means.
a. Method to eliminate recoil forces due to translation of said rotating centrifugal mass utilizing sets of centrifugal devices that are oscillating with an out of phase means.

2. The resonant oscillator methods of claim 1 producing said resonant arc motion employing magnetic field force tension means.

3. Centrifugal propulsion method employing centripetal magnetic levitation force means.
